(19) United States
(12) Patent Application Publication
(10) Pub. No.: US 2026/0030143 A1
(43) Pub. Date: Jan. 29, 2026

(54) TESTING SIMULATOR FOR ELECTRIC VEHICLE AND TESTING METHOD FOR ELECTRIC VEHICLE

(71) Applicant: DELTA ELECTRONICS, INC., Taoyuan City (TW)

(72) Inventors: Tien-He CHEN, Taoyuan City (TW); Yen-Po WANG, Taoyuan City (TW); Ren-Shiang YU, Taoyuan City (TW)

(21) Appl. No.: 19/043,732

(22) Filed: Feb. 3, 2025

Related U.S. Application Data
(60) Provisional application No. 63/675,985, filed on Jul. 26, 2024.

(30) Foreign Application Priority Data
Oct. 24, 2024 (CN) 202411494903.X

(51) Int. Cl. G06F 11/3668

(52) U.S. Cl. CPC G06F 11/3684

(57) ABSTRACT

A testing simulator for an electric vehicle includes a user interface setting a first electric vehicle communication protocol data and a second electric vehicle communication protocol data and a processing circuit storing a client main program. The user interface transmits the first electric vehicle communication protocol data to the processing circuit. The processing circuit imports the first electric vehicle communication protocol data into the client main program. The processing circuit receives a requested signal transmitted by a charging pile management-system apparatus adapted to the first electric vehicle communication protocol data in a wired manner. The processing circuit transmits a customized response signal corresponding to the requested signal to the charging pile management-system apparatus through the client main program using the first electric vehicle communication protocol data.

### CROSS-REFERENCE TO RELATED APPLICATION

This patent application claims the benefit of U.S. Provisional Patent Application No. 63/675,985 filed Jul. 26, 2024, which is incorporated by reference herein.

### BACKGROUND OF THE DISCLOSURE

### Technical Field

The present disclosure relates to a testing simulator and a testing method, and especially relates to a testing simulator for an electric vehicle and a testing method for an electric vehicle.

### Description of Related Art

With the rise of the electric vehicles (for example, the electric cars), the development of the charging pile apparatuses for charging the electric vehicles and the charging pile management-system apparatuses for managing the charging pile apparatuses have gradually attracted the attention and taken seriously.

During the testing process, the maintenance process, and the development process for the charging pile apparatus and the charging pile management-system apparatus, the program engineers may follow the standard procedures to debug the program codes and verify whether the content of the program codes is correct. However, during the testing process, the program engineers may encounter the following problems:

1. The program of the charging pile apparatus and the program of the charging pile management-system apparatus need to exist at the same time; namely, the separated program of the charging pile apparatus or the separated program of the charging pile management-system apparatus may not be verified independently.

2. Some parameters of the charging pile apparatus have to be obtained from some relevant external hardware apparatuses (for examples, a power supply equipment or a credit card verification apparatus); namely, a considerable number of large and complex hardware apparatuses have to be bundled with the charging pile apparatus to fully test the charging pile apparatus.

3. Because the parameter transfer needs to be hard-coded in the program codes, the program engineers need to find the parameters which need to be modified in the lengthy program codes and recompile the program, which greatly increases the process time of the testing operation.

4. Due to the lack of the clear specifications for the charging protocols, multiple charging protocols coexist, so that the research-and-development engineer's preparation work for the online verification is quite complex.

To sum up, during the testing process, the program engineers may encounter many problems, but there are currently no relevant solutions or methods that may easily solve these problems.

### SUMMARY OF THE INVENTION

In order to solve the above-mentioned problems, an object of the present disclosure is to provide a testing simulator for an electric vehicle.

In order to solve the above-mentioned problems, another object of the present disclosure is to provide a testing simulator for an electric vehicle.

In order to solve the above-mentioned problems, still another object of the present disclosure is to provide a testing simulator for an electric vehicle.

In order to solve the above-mentioned problems, yet another object of the present disclosure is to provide a testing method for an electric vehicle.

In order to achieve the object of the present disclosure mentioned above, the testing simulator of the present disclosure includes a user interface and a processing circuit. The user interface is configured to set a parameter of the testing simulator, wherein the parameter includes a first electric vehicle communication protocol data and a second electric vehicle communication protocol data. The processing circuit is electrically connected to the user interface and is configured to store a client main program. Moreover, the user interface is configured to transmit the first electric vehicle communication protocol data to the processing circuit. The processing circuit is configured to import the first electric vehicle communication protocol data into the client main program. The processing circuit is configured to receive a requested signal transmitted by a charging pile management-system apparatus adapted to the first electric vehicle communication protocol data in a wired manner. In response to receiving the requested signal, the processing circuit is configured to transmit a customized response signal corresponding to the requested signal to the charging pile management-system apparatus through the client main program using the first electric vehicle communication protocol data.

Moreover, in an embodiment of the testing simulator of the present disclosure mentioned above, the testing simulator further includes a network cable connected between the processing circuit and the charging pile management-system apparatus, so that the testing simulator and the charging pile management-system apparatus are configured to form a local area network.

Moreover, in an embodiment of the testing simulator of the present disclosure mentioned above, the processing circuit having a predetermined internet protocol address and the charging pile management-system apparatus having the predetermined internet protocol address are configured to communicate and access to each other and exchange the first electric vehicle communication protocol data through the predetermined internet protocol address.

Moreover, in an embodiment of the testing simulator of the present disclosure mentioned above, the processing circuit is connected to the charging pile management-system apparatus through a secure shell protocol and a websocket protocol.

In order to achieve the another object of the present disclosure mentioned above, the testing simulator of the present disclosure includes a user interface and a processing circuit. The user interface is configured to set a parameter of the testing simulator, wherein the parameter includes a first electric vehicle communication protocol data and a second electric vehicle communication protocol data. The processing circuit is electrically connected to the user interface and is configured to store a server main program. Moreover, the user interface is configured to transmit the first electric vehicle communication protocol data to the processing circuit. The processing circuit is configured to import the first electric vehicle communication protocol data into the server main program. The processing circuit is configured to transmit a requested signal to a charging pile apparatus adapted to the first electric vehicle communication protocol data through the server main program using the first electric vehicle communication protocol data in a wired manner. The processing circuit is configured to receive a customized response signal corresponding to the requested signal and transmitted by the charging pile apparatus in response to receiving the requested signal.

Moreover, in an embodiment of the testing simulator of the present disclosure mentioned above, the testing simulator further includes a network cable connected between the processing circuit and the charging pile apparatus, so that the testing simulator and the charging pile apparatus are configured to form a local area network.

Moreover, in an embodiment of the testing simulator of the present disclosure mentioned above, the processing circuit having a predetermined internet protocol address and the charging pile apparatus having the predetermined internet protocol address are configured to communicate and access to each other and exchange the first electric vehicle communication protocol data through the predetermined internet protocol address.

Moreover, in an embodiment of the testing simulator of the present disclosure mentioned above, the processing circuit is connected to the charging pile apparatus through a secure shell protocol and a websocket protocol.

In order to achieve the still another object of the present disclosure mentioned above, the testing simulator of the present disclosure includes a user interface and a processing circuit. The user interface is configured to set a parameter of the testing simulator, wherein the parameter includes a designed electric vehicle communication protocol data. The processing circuit is electrically connected to the user interface and is configured to store a server main program and a client main program. Moreover, the user interface is configured to transmit the designed electric vehicle communication protocol data to the processing circuit. The processing circuit is configured to import the designed electric vehicle communication protocol data into the server main program and the client main program. The server main program is configured to transmit a requested signal to the client main program using the designed electric vehicle communication protocol data. In response to receiving the requested signal, the client main program is configured to transmit a customized response signal corresponding to the requested signal to the server main program using the designed electric vehicle communication protocol data.

Moreover, in an embodiment of the testing simulator of the present disclosure mentioned above, the server main program and the client main program are connected to each other through a secure shell protocol and a websocket protocol. The server main program and the client main program are configured to form a local area network. The server main program having a predetermined internet protocol address and the client main program having the predetermined internet protocol address are configured to communicate and access to each other and exchange the designed electric vehicle communication protocol data through the predetermined internet protocol address.

In order to achieve the yet another object of the present disclosure mentioned above, the testing method of the present disclosure includes the following steps: A user interface selects a first electric vehicle communication protocol data, wherein the first electric vehicle communication protocol data and a second electric vehicle communication protocol data are stored in a software burn file located within the user interface. The user interface transmits the first electric vehicle communication protocol data to a processing circuit. The processing circuit imports the first electric vehicle communication protocol data into a client main program, or into a server main program, or into the client main program and the server main program, wherein the processing circuit stores the client main program, or stores the server main program, or stores the client main program and the server main program. The processing circuit receives or transmits a requested signal and a customized response signal, wherein the customized response signal is corresponding to the requested signal.

Moreover, in an embodiment of the testing method of the present disclosure mentioned above, a plurality of tested simulation function parameters of the first electric vehicle communication protocol data and the second electric vehicle communication protocol data are adjusted to be stored in the user interface.

Moreover, in an embodiment of the testing method of the present disclosure mentioned above, the processing circuit imports the first electric vehicle communication protocol data into the client main program. Moreover, that the processing circuit receives or transmits the requested signal and the customized response signal includes the following steps: The processing circuit receives the requested signal, wherein the requested signal is transmitted by a charging pile management-system apparatus adapted to the first electric vehicle communication protocol data. The processing circuit transmits the customized response signal corresponding to the requested signal to the charging pile management-system apparatus through the client main program using the first electric vehicle communication protocol data in response to receiving the requested signal.

Moreover, in an embodiment of the testing method of the present disclosure mentioned above, the processing circuit imports the first electric vehicle communication protocol data into the server main program. Moreover, that the processing circuit receives or transmits the requested signal and the customized response signal includes the following steps: The processing circuit transmits the requested signal to a charging pile apparatus adapted to the first electric vehicle communication protocol data through the server main program using the first electric vehicle communication protocol data. The processing circuit receives the customized response signal, wherein the customized response signal is corresponding to the requested signal and is transmitted by the charging pile apparatus in response to receiving the requested signal.

Moreover, in an embodiment of the testing method of the present disclosure mentioned above, the processing circuit imports the first electric vehicle communication protocol data into the server main program and the client main program. Moreover, that the processing circuit receives or transmits the requested signal and the customized response signal includes the following steps: The server main program transmits the requested signal to the client main program using the first electric vehicle communication protocol data. The client main program transmits the customized response signal corresponding to the requested signal to the server main program using the first electric vehicle communication protocol data in response to receiving the requested signal.

The advantage of the present disclosure is to increase the convenience of the related verification of the charging piles.

Please refer to the detailed descriptions and figures of the present disclosure mentioned below for further understanding technologies, methods, and effects and achieving the predetermined purposes of the present disclosure. Further, the purposes, characteristics, and features of the present disclosure may be more deeply and specifically understood. However, the drawings are provided only for references and descriptions and not intended to limit the scope of the present disclosure.

### BRIEF DESCRIPTION OF THE DRAWINGS

FIG. 1 shows a block diagram of the first embodiment of the testing simulator of the present disclosure.

FIG. 2 shows a block diagram of the second embodiment of the testing simulator of the present disclosure.

FIG. 3 shows a block diagram of the third embodiment of the testing simulator of the present disclosure.

FIG. 4 shows a simple schematic diagram of the verification of the management-system side of the present disclosure.

FIG. 5 shows a simple schematic diagram of the verification of the charging pile side of the present disclosure.

FIG. 6 shows a simple schematic diagram of the verification of the communication protocol of the present disclosure.

FIG. 7 shows a simple schematic diagram of an embodiment of the structure of the present disclosure.

FIG. 8 shows a flow chart of the testing method of the present disclosure.

### DETAILED DESCRIPTION

In the present disclosure, numerous specific details are provided, to provide a comprehensive understanding of embodiments of the present disclosure. However, those skilled in the art may understand that the present disclosure may be practiced without one or more of these specific details. In other instances, well-known details are not shown or described to avoid obscuring features of the present disclosure. The technical content and the detailed description of the present disclosure are as follows with reference to the figures.

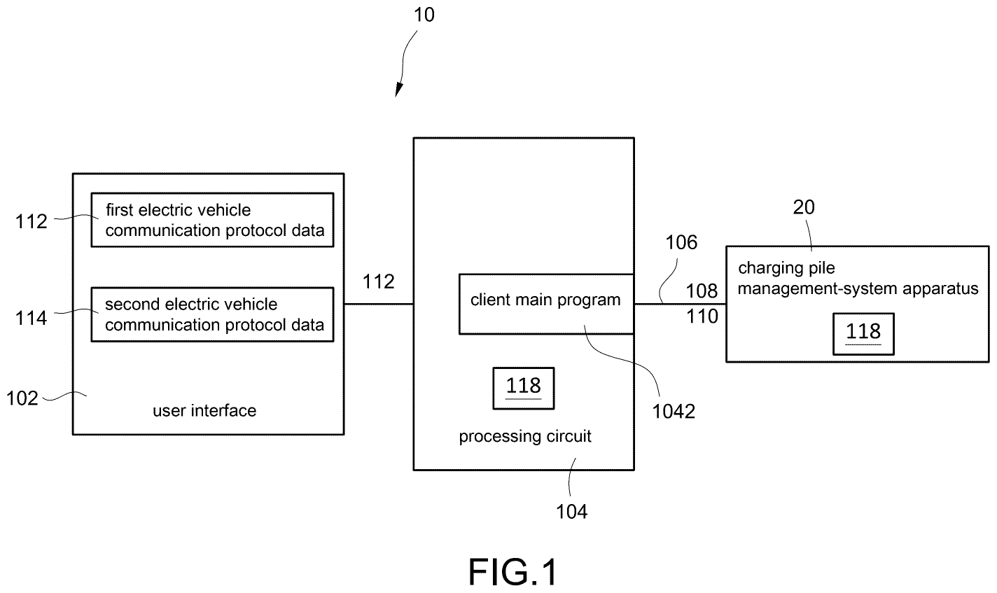

FIG. 1 shows a block diagram of the first embodiment of the testing simulator 10 of the present disclosure. The testing simulator 10 shown in FIG. 1 simulates a charging pile apparatus, and is applied to a charging pile management-system apparatus 20. The testing simulator 10 includes a user interface 102, a processing circuit 104, and a network cable 106. The user interface 102 is configured to set a parameter of the testing simulator 10, wherein the parameter includes a plurality of electric vehicle communication protocol data (for example, a first electric vehicle communication protocol data 112 and a second electric vehicle communication protocol data 114). The processing circuit 104 is electrically connected to the user interface 102 and is configured to store a client main program 1042. The processing circuit 104 is a processor, a microprocessor, a controller, or a microcontroller.

The network cable 106 is connected between the processing circuit 104 and the charging pile management-system apparatus 20, so that the testing simulator 10 and the charging pile management-system apparatus 20 are configured to form a local area network. The processing circuit 104 is connected to the charging pile management-system apparatus 20 through a secure shell (abbreviated as SSH) protocol and a websocket protocol. The charging pile management-system apparatus 20 is adapted to the first electric vehicle communication protocol data 112; namely, the charging pile management-system apparatus 20 communicates with external apparatuses (for example, a power supply equipment or a credit card verification apparatus) through the first electric vehicle communication protocol data 112.

Firstly, the user interface 102 is configured to transmit the first electric vehicle communication protocol data 112 to the processing circuit 104. For example, the first electric vehicle communication protocol data 112 is selected by a user (not shown in FIG. 1) through the user interface 102 and transmitted to the processing circuit 104 by the user interface 102, wherein the user knows that the charging pile management-system apparatus 20 is adapted to the first electric vehicle communication protocol data 112.

Then, the processing circuit 104 is configured to import the first electric vehicle communication protocol data 112 into the server main program 1042, wherein the processing circuit 104 has a predetermined internet protocol address 118 and the charging pile management-system apparatus 20 also has the predetermined internet protocol address 118, so that the processing circuit 104 and the charging pile management-system apparatus 20 are configured to communicate and access to each other and exchange the first electric vehicle communication protocol data 112 through the predetermined internet protocol address 118.

Then, the charging pile management-system apparatus 20 transmits a requested signal 108 to the processing circuit 104 in a wired manner. The processing circuit 104 is configured to receive the requested signal 108 transmitted by the charging pile management-system apparatus 20 in the wired manner. In response to receiving the requested signal 108, the processing circuit 104 is configured to transmit a customized response signal 110 corresponding to the requested signal 108 to the charging pile management-system apparatus 20 through the client main program 1042 using the first electric vehicle communication protocol data 112. Finally, the processing circuit 104 is configured to determine whether the above-mentioned overall content (for example, the requested signal 108, the customized response signal 110, and the first electric vehicle communication protocol data 112) is correct.

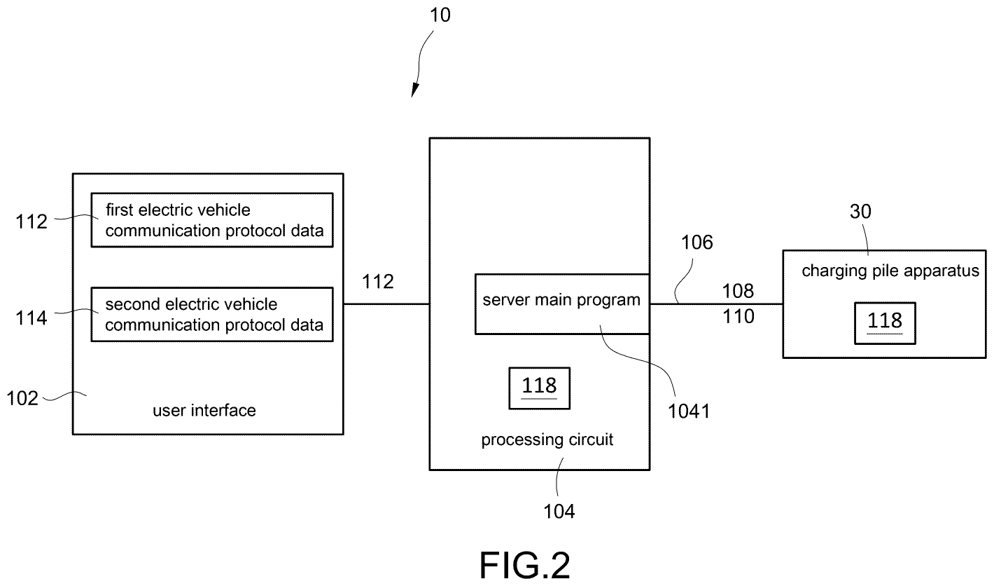

FIG. 2 shows a block diagram of the second embodiment of the testing simulator 10 of the present disclosure. The testing simulator 10 shown in FIG. 2 simulates a charging pile management-system apparatus, and is applied to a charging pile apparatus 30. The testing simulator 10 includes a user interface 102, a processing circuit 104, and a network cable 106. The user interface 102 is configured to set a parameter of the testing simulator 10, wherein the parameter includes a plurality of electric vehicle communication protocol data (for example, a first electric vehicle communication protocol data 112 and a second electric vehicle communication protocol data 114). The processing circuit 104 is electrically connected to the user interface 102 and is configured to store a server main program 1041. The processing circuit 104 is a processor, a microprocessor, a controller, or a microcontroller.

The network cable 106 is connected between the processing circuit 104 and the charging pile apparatus 30, so that the testing simulator 10 and the charging pile apparatus 30 are configured to form a local area network. The processing circuit 104 is connected to the charging pile apparatus 30 through a secure shell protocol and a websocket protocol. The charging pile apparatus 30 is adapted to the first electric vehicle communication protocol data 112; namely, the charging pile apparatus 30 communicates with external apparatuses through the first electric vehicle communication protocol data 112.

Firstly, the user interface 102 is configured to transmit the first electric vehicle communication protocol data 112 to the processing circuit 104. For example, the first electric vehicle communication protocol data 112 is selected by a user (not shown in FIG. 2) through the user interface 102 and transmitted to the processing circuit 104 by the user interface 102, wherein the user knows that the charging pile apparatus 30 is adapted to the first electric vehicle communication protocol data 112.

Then, the processing circuit 104 is configured to import the first electric vehicle communication protocol data 112 into the server main program 1041, wherein the processing circuit 104 has a predetermined internet protocol address 118 and the charging pile apparatus 30 also has the predetermined internet protocol address 118, so that the processing circuit 104 and the charging pile apparatus 30 are configured to communicate and access to each other and exchange the first electric vehicle communication protocol data 112 through the predetermined internet protocol address 118.

Then, the processing circuit 104 is configured to transmit a requested signal 108 to the charging pile apparatus 30 through the server main program 1041 using the first electric vehicle communication protocol data 112 in a wired manner. The charging pile apparatus 30 receives the requested signal 108 in the wired manner. In response to receiving the requested signal 108, the charging pile apparatus 30 transmits a customized response signal 110 corresponding to the requested signal 108 to the processing circuit 104. The processing circuit 104 is configured to receive the customized response signal 110 corresponding to the requested signal 108 and transmitted by the charging pile apparatus 30 in response to receiving the requested signal 108. Finally, the processing circuit 104 is configured to determine whether the above-mentioned overall content (for example, the requested signal 108, the customized response signal 110, and the first electric vehicle communication protocol data 112) is correct.

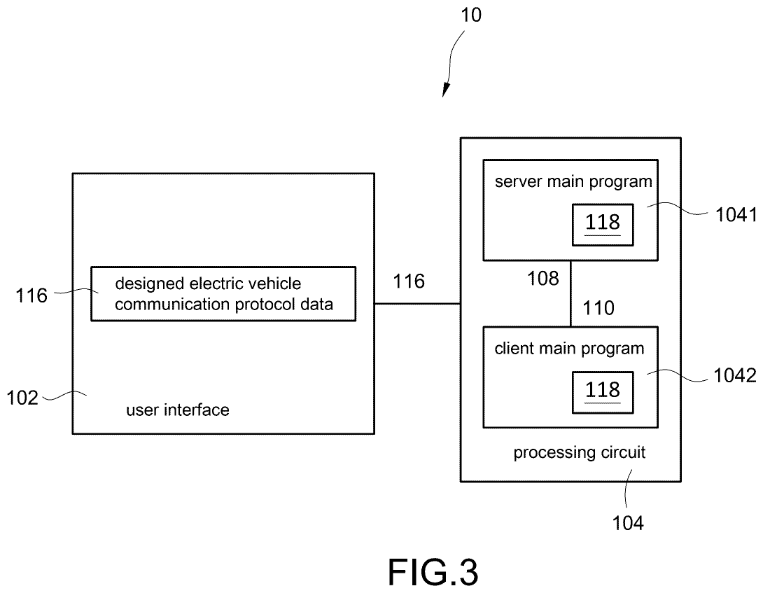

FIG. 3 shows a block diagram of the third embodiment of the testing simulator 10 of the present disclosure. The testing simulator 10 shown in FIG. 3 simulates a charging pile management-system apparatus and a charging pile apparatus. The testing simulator 10 includes a user interface 102 and a processing circuit 104. The user interface 102 is configured to set a parameter of the testing simulator 10, wherein the parameter includes a plurality of electric vehicle communication protocol data (for example, a designed electric vehicle communication protocol data 116 and other electric vehicle communication protocol data which are not shown in FIG. 3). The processing circuit 104 is electrically connected to the user interface 102 and is configured to store a server main program 1041 (which simulates the charging pile management-system apparatus) and a client main program 1042 (which simulates the charging pile apparatus). The processing circuit 104 is a processor, a microprocessor, a controller, or a microcontroller.

The server main program 1041 and the client main program 1042 are configured to form a local area network. The server main program 1041 and the client main program 1042 are connected to each other through a secure shell protocol and a websocket protocol.

Firstly, the user interface 102 is configured to transmit the designed electric vehicle communication protocol data 116 to the processing circuit 104. For example, the designed electric vehicle communication protocol data 116 is selected by a user (not shown in FIG. 3) through the user interface 102 and transmitted to the processing circuit 104 by the user interface 102.

Then, the processing circuit 104 is configured to import the designed electric vehicle communication protocol data 116 into the server main program 1041 and the client main program 1042, wherein the server main program 1041 has a predetermined internet protocol address 118 and the client main program 1042 also has the predetermined internet protocol address 118, so that the server main program 1041 and the client main program 1042 are configured to communicate and access to each other and exchange the designed electric vehicle communication protocol data 116 through the predetermined internet protocol address 118.

Then, the server main program 1041 is configured to transmit a requested signal 108 to the client main program 1042 using the designed electric vehicle communication protocol data 116. In response to receiving the requested signal 108, the client main program 1042 is configured to transmit a customized response signal 110 corresponding to the requested signal 108 to the server main program 1041 using the designed electric vehicle communication protocol data 116. Finally, the processing circuit 104 is configured to determine whether the above-mentioned overall content (for example, the requested signal 108, the customized response signal 110, and the designed electric vehicle communication protocol data 116) is correct.

In summary, the present disclosure is related to the content testing of the communication protocol of the management-system side or the charging pile side which have been completed and designed. In view of the current program development of various charging apparatuses, the engineers carry out the development so that the present disclosure may be applied to a variety of apparatuses. The present disclosure constructs the testing system with the communication protocol structure, including a server side and a client side. The present disclosure may select the corresponding side to connect based on the items that the user wants to test and verify, including the following three modes:

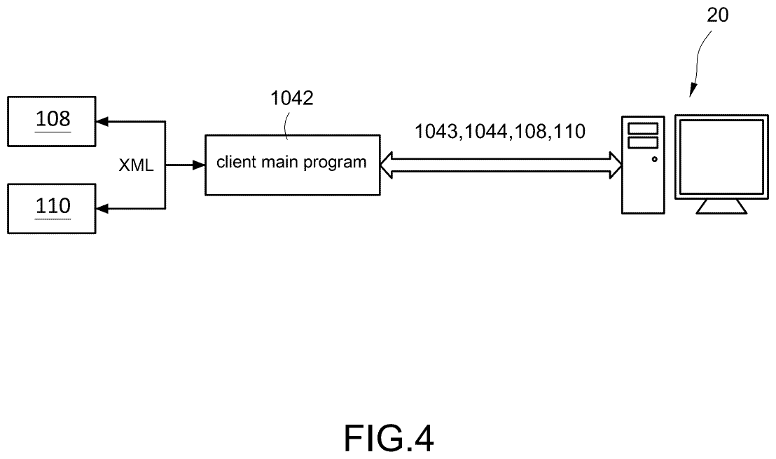

1. The verification of the management-system side: Please refer to FIG. 1 again. The charging pile management-system apparatus 20 mentioned above is connected to the client side system (namely, the client main program 1042 mentioned above) of the present disclosure. The client side system (namely, the client main program 1042 mentioned above) of the present disclosure receives the message transmitted by the management-system side (namely, the charging pile management-system apparatus 20 mentioned above) and returns the customized content. FIG. 4 shows a simple schematic diagram of the verification of the management-system side of the present disclosure. The client main program 1042 is connected to the charging pile management-system apparatus 20 through a secure shell protocol 1043 and a websocket protocol 1044 to transmit the requested signal 108 and the customized response signal 110 to each other. The client main program 1042 further transmits and receives the requested signal 108 and the customized response signal 110 through an extensible markup language XML. The client main program 1042 is installed in an integrated circuit (not shown in FIG. 4). The charging pile management-system apparatus 20 is a computer apparatus including a host, a screen, a keyboard, and a mouse.

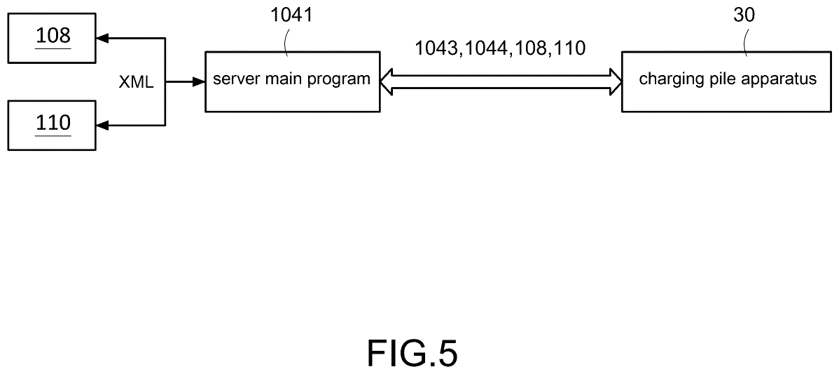

2. The verification of the charging pile side: Please refer to FIG. 2 again. The charging pile apparatus 30 mentioned above is connected to the server side system (namely, the server main program 1041 mentioned above) of the present disclosure. The server side system (namely, the server main program 1041 mentioned above) of the present disclosure transmits the specified message to the charging pile side (namely, the charging pile apparatus 30 mentioned above) by using the command, and then the server side system (namely, the server main program 1041 mentioned above) of the present disclosure collects the results transmitted by the charging pile apparatus 30 mentioned above. FIG. 5 shows a simple schematic diagram of the verification of the charging pile side of the present disclosure. The server main program 1041 is connected to the charging pile apparatus 30 through a secure shell protocol 1043 and a websocket protocol 1044 to transmit the requested signal 108 and the customized response signal 110 to each other. The server main program 1041 further transmits and receives the requested signal 108 and the customized response signal 110 through an extensible markup language XML. The server main program 1041 is installed in a notebook computer (not shown in FIG. 5).

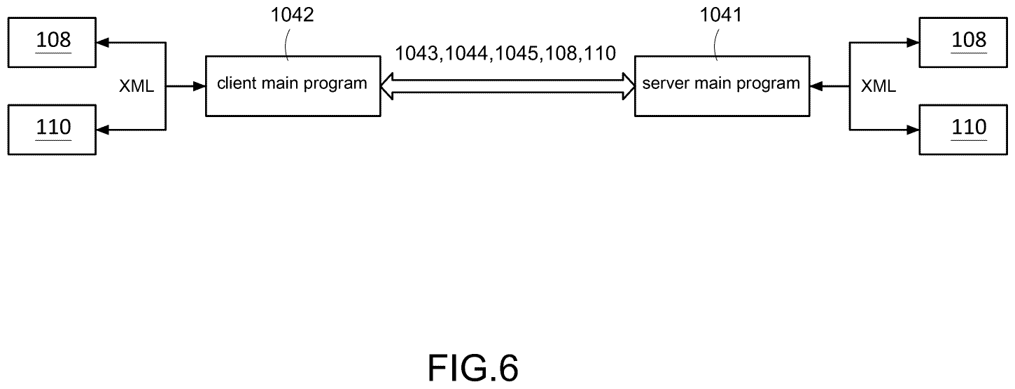

3. The verification of the communication protocol: Please refer to FIG. 3 again. The present disclosure imports the communication protocol structure into the server side (namely, the server main program 1041 mentioned above) and the client side (namely, the client main program 1042 mentioned above) respectively, and then the present disclosure tests whether there is any error in the message transmission process by using the client/server architecture. FIG. 6 shows a simple schematic diagram of the verification of the communication protocol of the present disclosure. The server main program 1041 is connected to the client main program 1042 through a secure shell protocol 1043 and a websocket protocol 1044 to transmit the requested signal 108 and the customized response signal 110 to each other to verify whether the communication protocol 1045 is correct. The server main program 1041 further transmits and receives the requested signal 108 and the customized response signal 110 through an extensible markup language XML. The client main program 1042 further transmits and receives the requested signal 108 and the customized response signal 110 through an extensible markup language XML. The client main program 1042 is installed in an integrated circuit (not shown in FIG. 6). The server main program 1041 is installed in a notebook computer (not shown in FIG. 6).

The present disclosure constructs a standard-based communication system, which may be used in various types of charging equipment, charging devices provided by different suppliers, and different types of charging protocols based on the communication mode of web socket. The present disclosure may be used separately without being connected to the Internet. The corresponding client side (or the corresponding server side) is wired and connected to the tested side to transmit and receive messages. The transmission content may be dynamically adjusted to maintain the user flexibility. The program developers are conveniently to perform the program maintenance and the system updates.

The present disclosure includes the following advantages and features:

1. Compatibility: the present disclosure packages the communication protocol-related content and the data structure in a class manner, and then imports it into the basic communication environment. The present disclosure may select the data structure package to be imported. The present disclosure may import different data packages to perform the communication protocol testing.

2. Convenience: the present disclosure connects the server side and the client side in a wired manner (for example, through a network cable) to form a small local area network (LAN); in this connection, the server side and the client side may access to each other and exchange the communication protocol through the same internet protocol address. The server main program 1041 and the client main program 1042 mentioned above may be burned into an embedded system board or a black box for use, greatly reducing the size of the apparatus.

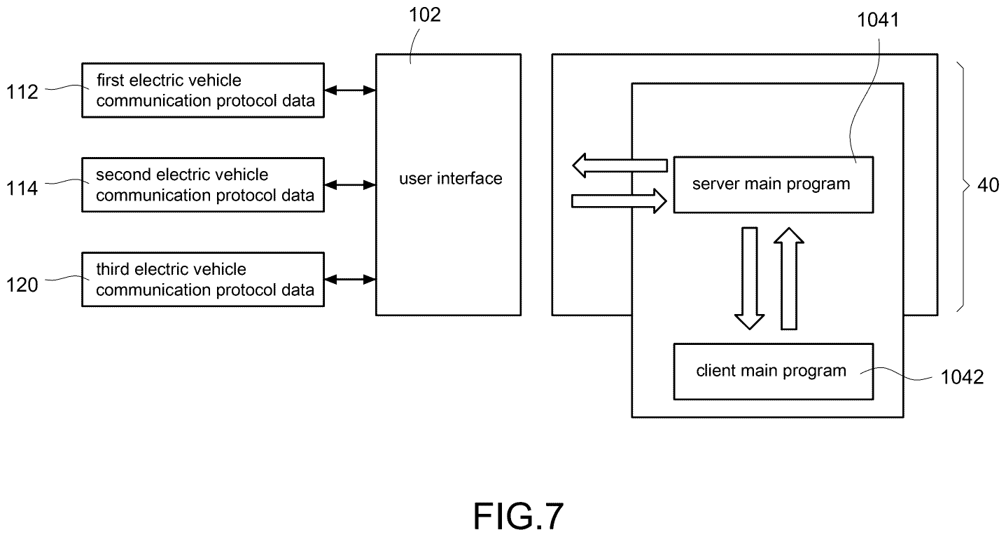

FIG. 7 shows a simple schematic diagram of an embodiment of the structure of the present disclosure. The user interface 102 sets a parameter, wherein the parameter includes a plurality of electric vehicle communication protocol data (for example, a first electric vehicle communication protocol data 112, a second electric vehicle communication protocol data 114, and a third electric vehicle communication protocol data 120). The server main program 1041 and the client main program 1042 are connected to each other in a wired manner to form a small local area network, and are connected to each other through a secure shell protocol and a websocket protocol to exchange the communication protocol, and may be burned into a black box 40 for use. The user interface 102 imports the data structure packet (namely, the first electric vehicle communication protocol data 112, the second electric vehicle communication protocol data 114, or the third electric vehicle communication protocol data 120) into the server main program 1041 and/or the client main program 1042 to confirm whether the verified communication protocol is correct.

Through the user interface 102 mentioned above, various related simulation parameters may be set, such as test environment parameters, test device parameters, and so on. In an embodiment of the present disclosure, the first electric vehicle communication protocol data 112, the second electric vehicle communication protocol data 114, the designed electric vehicle communication protocol data 116, and the third electric vehicle communication protocol data 120 are burned into the software burn file. The testing simulator 10 may use the software burn file to expand and add the first electric vehicle communication protocol data 112, the second electric vehicle communication protocol data 114, the designed electric vehicle communication protocol data 116, and the third electric vehicle communication protocol data 120; other relevant simulation parameters are set through the user interface 102.

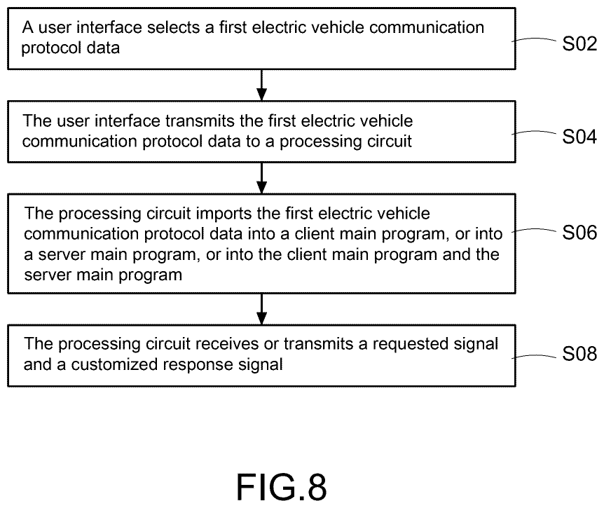

FIG. 8 shows a flow chart of the testing method of the present disclosure. The testing method of the present disclosure includes the following steps:

Step S02: A user interface selects a first electric vehicle communication protocol data, wherein the first electric vehicle communication protocol data and a second electric vehicle communication protocol data are stored in a software burn file located within the user interface. Then, the testing method of the present disclosure goes to the step S04.

Step S04: The user interface transmits the first electric vehicle communication protocol data to a processing circuit. Then, the testing method of the present disclosure goes to the step S06.

Step S06: The processing circuit imports the first electric vehicle communication protocol data into a client main program, or into a server main program, or into the client main program and the server main program, wherein the processing circuit stores the client main program, or stores the server main program, or stores the client main program and the server main program. Then, the testing method of the present disclosure goes to the step S08.

Step S08: The processing circuit receives or transmits a requested signal and a customized response signal, wherein the customized response signal is corresponding to the requested signal.

Moreover, a plurality of tested simulation function parameters of the first electric vehicle communication protocol data and the second electric vehicle communication protocol data are adjusted to be stored in the user interface.

In an embodiment of the step S06 mentioned above, the processing circuit imports the first electric vehicle communication protocol data into the client main program. The step S08 mentioned above includes the following steps: The processing circuit receives the requested signal, wherein the requested signal is transmitted by a charging pile management-system apparatus adapted to the first electric vehicle communication protocol data. The processing circuit transmits the customized response signal corresponding to the requested signal to the charging pile management-system apparatus through the client main program using the first electric vehicle communication protocol data in response to receiving the requested signal.

In another embodiment of the step S06 mentioned above, the processing circuit imports the first electric vehicle communication protocol data into the server main program. The step S08 mentioned above includes the following steps: The processing circuit transmits the requested signal to a charging pile apparatus adapted to the first electric vehicle communication protocol data through the server main program using the first electric vehicle communication protocol data. The processing circuit receives the customized response signal, wherein the customized response signal is corresponding to the requested signal and is transmitted by the charging pile apparatus in response to receiving the requested signal.

In still another embodiment of the step S06 mentioned above, the processing circuit imports the first electric vehicle communication protocol data into the server main program and the client main program. The step S08 mentioned above includes the following steps: The server main program transmits the requested signal to the client main program using the first electric vehicle communication protocol data. The client main program transmits the customized response signal corresponding to the requested signal to the server main program using the first electric vehicle communication protocol data in response to receiving the requested signal.

A related art verification system obtains various status information of the charging site through the cloud server (for example, the number of the charging piles at the charging site, the number of the electric vehicles, the grid power supply information, the renewable energy information, the energy storage system information, various parameters, and so on) to perform the simulated situation testing. The present disclosure uses the portable test equipment on the local side (namely, the testing simulator 10) to firstly select the communication protocol, and then the user may set various parameters in the simulation situation, and then the testing may be performed. Various environmental parameters of the charging station (for example, the charging pile apparatus 30, the number of the charging guns of the charging pile apparatus 30, the information of the electric vehicles, the changes in the numbers of the electric vehicles being charged, the time electricity price of the power grid, the amount of the renewable energy generation, the state of charge (usually abbreviated as SOC) of the energy storage system, and so on) are also simulated by the testing simulator 10.

The advantage of the present disclosure is to increase the convenience of the related verification of the charging piles. Namely, the main function of the present disclosure is that in response to the charging piles of different brands with different communication protocol specifications, the disclosure may switch to select the desired communication protocol. If there is a new communication protocol, the present disclosure may also flexibly add the new communication protocol into the testing simulator 10 of the present disclosure.

Although the present disclosure has been described with reference to the embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure.

What is claimed is:

1. A testing simulator comprising:
a user interface configured to set a parameter of the testing simulator, wherein the parameter comprises a first electric vehicle communication protocol data and a second electric vehicle communication protocol data; and
a processing circuit electrically connected to the user interface and configured to store a client main program,
wherein the user interface is configured to transmit the first electric vehicle communication protocol data to the processing circuit; the processing circuit is configured to import the first electric vehicle communication protocol data into the client main program; the processing circuit is configured to receive a requested signal transmitted by a charging pile management-system apparatus adapted to the first electric vehicle communication protocol data; in response to receiving the requested signal, the processing circuit is configured to transmit a customized response signal corresponding to the requested signal to the charging pile management-system apparatus through the client main program using the first electric vehicle communication protocol data.

2. The testing simulator of claim 1, further comprising:
a network cable connected between the processing circuit and the charging pile management-system apparatus, so that the testing simulator and the charging pile management-system apparatus are configured to form a local area network.

3. The testing simulator of claim 2, wherein the processing circuit having a predetermined internet protocol address and the charging pile management-system apparatus having the predetermined internet protocol address are configured to communicate and access to each other and exchange the first electric vehicle communication protocol data through the predetermined internet protocol address.

4. The testing simulator of claim 3, wherein the processing circuit is connected to the charging pile management-system apparatus through a secure shell protocol and a websocket protocol.

5. A testing simulator comprising:
a user interface configured to set a parameter of the testing simulator, wherein the parameter comprises a first electric vehicle communication protocol data and a second electric vehicle communication protocol data; and
a processing circuit electrically connected to the user interface and configured to store a server main program,
wherein the user interface is configured to transmit the first electric vehicle communication protocol data to the processing circuit; the processing circuit is configured to import the first electric vehicle communication protocol data into the server main program; the processing circuit is configured to transmit a requested signal to a charging pile apparatus adapted to the first electric vehicle communication protocol data through the server main program using the first electric vehicle communication protocol data; the processing circuit is configured to receive a customized response signal corresponding to the requested signal and transmitted by the charging pile apparatus in response to receiving the requested signal.

6. The testing simulator of claim 5, further comprising:
a network cable connected between the processing circuit and the charging pile apparatus, so that the testing simulator and the charging pile apparatus are configured to form a local area network.

7. The testing simulator of claim 6, wherein the processing circuit having a predetermined internet protocol address and the charging pile apparatus having the predetermined internet protocol address are configured to communicate and access to each other and exchange the first electric vehicle communication protocol data through the predetermined internet protocol address.

8. The testing simulator of claim 7, wherein the processing circuit is connected to the charging pile apparatus through a secure shell protocol and a websocket protocol.

9. A testing simulator comprising:
a user interface configured to set a parameter of the testing simulator, wherein the parameter comprises a designed electric vehicle communication protocol data; and
a processing circuit electrically connected to the user interface and configured to store a server main program and a client main program,
wherein the user interface is configured to transmit the designed electric vehicle communication protocol data to the processing circuit; the processing circuit is configured to import the designed electric vehicle communication protocol data into the server main program and the client main program; the server main program is configured to transmit a requested signal to the client main program using the designed electric vehicle communication protocol data; in response to receiving the requested signal, the client main program is configured to transmit a customized response signal corresponding to the requested signal to the server main program using the designed electric vehicle communication protocol data.

10. The testing simulator of claim 9, wherein the server main program and the client main program are connected to each other through a secure shell protocol and a websocket protocol; the server main program and the client main program are configured to form a local area network; the server main program having a predetermined internet protocol address and the client main program having the predetermined internet protocol address are configured to communicate and access to each other and exchange the designed electric vehicle communication protocol data through the predetermined internet protocol address.

11. A testing method comprising:
selecting a first electric vehicle communication protocol data by a user interface, wherein the first electric vehicle communication protocol data and a second electric vehicle communication protocol data are stored in a software burn file located within the user interface;
transmitting the first electric vehicle communication protocol data to a processing circuit by the user interface;
importing the first electric vehicle communication protocol data into a client main program, or into a server main program, or into the client main program and the server main program, by the processing circuit, wherein the processing circuit stores the client main program, or stores the server main program, or stores the client main program and the server main program; and
receiving or transmitting a requested signal and a customized response signal by the processing circuit, wherein the customized response signal is corresponding to the requested signal.

12. The testing method of claim 11, wherein a plurality of tested simulation function parameters of the first electric vehicle communication protocol data and the second electric vehicle communication protocol data are adjusted to be stored in the user interface.

13. The testing method of claim 11, wherein the processing circuit imports the first electric vehicle communication protocol data into the client main program; receiving or transmitting the requested signal and the customized response signal by the processing circuit comprises:
receiving the requested signal by the processing circuit, wherein the requested signal is transmitted by a charging pile management-system apparatus adapted to the first electric vehicle communication protocol data; and
transmitting the customized response signal corresponding to the requested signal to the charging pile management-system apparatus through the client main program using the first electric vehicle communication protocol data by the processing circuit in response to receiving the requested signal.

14. The testing method of claim 11, wherein the processing circuit imports the first electric vehicle communication protocol data into the server main program; receiving or transmitting the requested signal and the customized response signal by the processing circuit comprises:
transmitting the requested signal to a charging pile apparatus adapted to the first electric vehicle communication protocol data through the server main program using the first electric vehicle communication protocol data by the processing circuit; and
receiving the customized response signal by the processing circuit, wherein the customized response signal is corresponding to the requested signal and is transmitted by the charging pile apparatus in response to receiving the requested signal.

15. The testing method of claim 11, wherein the processing circuit imports the first electric vehicle communication protocol data into the server main program and the client main program; receiving or transmitting the requested signal and the customized response signal by the processing circuit comprises:
transmitting the requested signal to the client main program using the first electric vehicle communication protocol data by the server main program; and
transmitting the customized response signal corresponding to the requested signal to the server main program using the first electric vehicle communication protocol data by the client main program in response to receiving the requested signal.
